(19) United States
(12) Patent Application Publication
(10) Pub. No.: US 2010/0187022 A1
(43) Pub. Date: Jul. 29, 2010

(54) PALLET WITH SCALE

(76) Inventors: Fathi Saigh, Laval (CA); Kennard Wottowa, Chicago, IL (US)

Correspondence Address: THE ECLIPSE GROUP LLP, 10605 BALBOA BLVD., SUITE 300, GRANADA HILLS, CA, 91344, US

(21) Appl. No.: 12/602,146

(22) PCT Filed: May 29, 2008
(86) PCT No.: PCT/CA2008/001023

§ 371 Date: Nov. 27, 2009

(30) Foreign Application Priority Data
May 29, 2007 (CA) 2590185
May 29, 2007 (CA) 2590467

(51) Int. Cl. G01G 19/52

(52) U.S. Cl. 177/132

(57) ABSTRACT

An industrial pallet/scale including a platform for supporting a load, having at least three load sensors positioned between and in mechanical communication with the platform and ground. The platform is free of a sheer plate assembly in order to minimize weight of the platform. Each load sensor provides weight data responsive to a downward force relayed from the platform. A display unit in electrical communication with the at least three load cells displays text in response to the weight data of each load cell. The industrial pallet/scale optionally includes load sensors having protection means for protecting the load cells. The protection means functions as a support for the platform, which bears the load of the platform in a protective position. The protection means prevents a pressure member of the load cell from contacting the ground. In a weighing position, the pressure member is coupled directly to the ground, such that the load cell of the load sensor bears the load of the platform.

### FIELD OF THE INVENTION

The present invention relates generally to industrial scales and, more particularly, it relates to industrial pallets used for weighing loads.

### BACKGROUND OF THE INVENTION

Commercial floor scales are used throughout industry to weigh raw materials, finished goods, shipments and other items involved in commerce. Existing commercial floor scales utilize a relatively standard construction consisting of a metal weighing platform, up to four load cells, a junction box, and a display unit. The current generation of floor scales lacks several advantages. For example, there are no lightweight (under 25 kg), portable, high-capacity (over 500 kg) floor scales. No existing floor scales utilize a pallet or similar construction as its weighing platform. Existing floor scales employ shear-beam activated load cells without mechanisms to protect the load cell from damage during transport or from harsh industrial environments. There are also no floor scales which utilize five or more load cells to determine accurately the weight of objects.

Floor scales are used in commercial settings for the weighing of a wide variety of objects. Due to their heavy-duty construction (most weigh over 100 kg), such scales are not readily movable within the factory floor and are too cumbersome to be transported for use in multiple locations. In addition, such scales rely on four shear-beam activated load cells which require a shear plate to transfer the force of the load from the platform. Such design limits the range of materials which can be used in construction of the platform. Existing shop floor scales also incur high repair costs due to a common design element in which electrical cables are integral to the load cell. When, as is a common issue, the cable fails, the entire load cell/cable assembly must be replaced by a skilled technician.

Accordingly, there is a need for an industrial scale that addresses these shortcomings by eliminating the shear beam construction requirement and utilizing new load cell designs and platform configurations to reduce the scale's weight, improve its portability and ease maintenance.

### SUMMARY OF THE INVENTION

It is an object of the present invention to obviate or mitigate at least one disadvantage of previous floor scales. In a first aspect, the present invention provides an industrial pallet. The industrial pallet includes a platform free of a shear plate assembly, load sensors and a display unit. The platform supports a load, and the load sensors support the platform over a surface. Each of the load sensors include a load cell having a pressure member coupled to the surface and coupled to a strain gauge for providing weight data in response to a downward force of the load. The display unit is in data communication with the load sensors for displaying a weight corresponding to the load when the protection means is in the weighing position. The display unit can include one of an LCD display and an LED display, and be in data communication with at least one computer having a Central Processing Unit (CPU) and a monitor. The display unit can be the monitor of the computer. In an embodiment of the present aspect, each of the load sensors further includes protection means for supporting the platform on the surface and preventing the downward force from being relayed to the pressure member in a protective position. The protection means couples the pressure member to the surface in a weighing position. The protection means can include an extension foot for coupling the pressure member to the surface in the weighing position, and spacing means for supporting the platform on the surface in the protective position.

In one particular embodiment, the spacing means includes support members extending from an undersurface of the platform towards the surface beyond the pressure member by a distance of X in the protective position, and the extension foot is insertable between the pressure member and the surface in the weighing position, the extension foot having a thickness of Y greater than X. The extension foot is connected to a resilient support arm pivotably connected to a body of the load sensor. In another particular embodiment, the extension foot includes a cup-shaped spacer having a base and an integral sidewall extending from the horizontal base and terminating in a rim. The cup-shaped spacer substantially houses the load cell while supporting the platform on the surface in the protective position. The cup-shaped spacer is invertable in the weighing position where the base engages the pressure member and the rim rests on the surface. In yet another particular embodiment, the spacing means includes an annular wall surrounding the load cell and extending downwardly towards the ground beyond the pressure member, and the extension foot is in threaded engagement with the pressure member. The extension foot extends beyond the annular wall for contacting the surface in the weighing position, and is retractable to be suspended within the annular wall in the protective position.

In another embodiment of the present aspect, there is provided a junction box for receiving the weight data of each load sensor, and for providing aggregate weight data to the display unit. In this embodiment, the junction box includes standard input jacks for releasably receiving first complementary plugs connected to each of the load sensors, and a standard output jack for releasably receiving a second complementary plug connected to the display unit. The junction box is permanently sealed for securing the standard input jacks and the standard output jack. The junction box can include a summing board having a signal bus connected to the standard output jack, where each standard input jack has a set of wires connected in parallel to the signal bus. The standard input jacks and the standard output jack includes one of an RJ-11 and an RJ-45 jack, and the first complementary plugs and the second complementary plug includes one of an RJ-11 and an RJ-45 plug, respectively.

In yet a further embodiment of the present aspect, the platform includes at least two foldable sections foldable with respect to each another about at least one folding axis, where the at least two foldable sections are foldable between a planar position and a folded position. Locking means are provided for releasably locking the pallet in the folded position. The platform can be constructed of a thermoplastic material to include at least one hinge-forming groove between adjacent foldable sections for providing a pliable hinge connection to allow the two adjacent foldable sections to fold between the planar position and the folded position. In an alternate embodiment, the platform includes a central section adjacent to two end sections foldable towards each other and relative to the central section at corresponding folding axis′. Each of the two end sections are foldable up to a substantially 90-degree angle relative to the central section for housing the load sensors. The pallet can include a handle connected to a first end of the platform for lifting the first end to an inclined position, and a plurality of wheels connected to a second end of the platform opposite the first end for engaging the surface when the platform is lifted into the inclined position.

In a second aspect, the present invention provides a load sensor mountable to an undersurface of a platform. The load sensor includes a load cell and protection means. The load cell has a pressure member coupled to a surface and physically connected to a strain gauge for providing weight data in response to a force applied to the platform. The protection means supports the platform and inhibits the downward force from being coupled to the load cell in a protective position, the protection means couples the pressure member to the surface in a weighing position. In one embodiment of the present aspect, the protection means includes an extension foot for coupling the pressure member to the surface in the weighing position, and spacing means for supporting the platform on the surface in the protective position. In one particular embodiment, the spacing means can include support members surrounding the load cell for supporting the platform on the surface, where the support members extend from the undersurface towards the surface beyond the pressure member by a distance of X in the protective position, and the extension foot is insertable between the pressure member and the surface in the weighing position. The extension foot has a thickness of Y greater than X. In this embodiment, the extension foot is connected to a resilient support arm pivotably connected to a body of the load sensor.

In another particular embodiment, the extension foot includes a cup-shaped spacer having a base and an integral sidewall extending from the horizontal base and terminating in a rim. The cup-shaped spacer substantially houses the load cell while supporting the platform on the surface in the protective position. The cup-shaped spacer is invertable in the weighing position where the base engages the pressure member and the rim rests on the surface. In yet another particular embodiment, the spacing means includes an annular wall surrounding the load cell, which extends downwardly towards the ground beyond the pressure member, and the extension foot is in threaded engagement with the pressure member. The extension foot extends beyond the annular wall for contacting the surface in the weighing position, and is retractable to be suspended within the annular wall in the protective position.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a perspective view of a load sensor according to an embodiment of the invention;

FIGS. 2A and 2B are top and bottom perspective views of a load cell including a support structure;

FIG. 3 is a perspective view of a nestable pallet with load sensors fitted to each leg according to an embodiment of the present invention;

FIG. 4 is a perspective view of a stackable pallet according to an embodiment of the present invention;

FIG. 5 is a schematic of a a junction box for use with the nestable pallet and stackable pallet of FIGS. 3 and 4;

FIG. 6 is a perspective view of a display unit for use with the nestable pallet and stackable pallet of FIGS. 3 and 4;

FIGS. 7 and 8 are cross-sectional side views of a load sensor according to an embodiment of the invention showing the load cell in the protected and weighing positions, respectively;

FIG. 9 is a bottom view of the load sensor of FIGS. 7 and 8;

FIGS. 10 and 11 are cross-sectional side views of an alternate load sensor according to an embodiment of the invention;

FIG. 12 is a bottom view of the load sensor used with the protection means of FIGS. 10 and 11;

FIGS. 13 and 14 are cross-sectional side views of an alternate load cell according to an embodiment of the invention showing the load cell in the protected and weighing positions, respectively;

FIG. 15 is a bottom view of a foldable pallet according to an embodiment of the invention;

FIG. 16 is a top-down view view of the pallet of FIG. 15 in the folded position when lifted; and,

FIG. 17 is a rear view of the pallet of FIG. 15 in the folded position when lifted.

### DETAILED DESCRIPTION

The following description and accompanying drawings are presented to enable any person skilled in the art to make use of the invention and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown, but is to be accorded the widest scope consistent with the principles and features disclosed herein. The appended claims, properly construed, form the only limitation upon the scope of the invention.

The present invention is described with the environment of industrial pallets in mind; however, it is to be understood that the embodiments of the invention described and illustrated herein are applicable to a broad class of apparatus including platforms which can be converted into a scale, and the presently described embodiments are not limited to the application to pallets.

It is to be understood that in this document, the term “load sensor” is used in reference to a load cell including its housing and/or all the elements that are associated therewith, such as a mechanical relay or an electrical connection such as a jack. It is also to be understood that terms such as “a housed load cell” and “a partially housed load cell” refer to the housing or partial housing of the load cell.

The embodiments of the present invention are directed to an industrial pallet/scale including a shear beam free and/or shear plate-free platform for supporting a load, having at least three load sensors positioned between and in mechanical communication with the platform and ground. The use of a platform free of a sheer beam and/or shear plate significantly reduces the weight of the metal that is needed to support the shear plates of the platform itself, relative to existing floor scales. Each load sensor provides weight data responsive to a downward force relayed from the platform. A display unit in electrical communication with the at least three load cells displays text in response to the weight data of all the load cells. The industrial pallet/scale optionally includes load sensors having protection means for protecting the load cells. The protection means functions as a support for the platform, which bears the load of the platform in a protective position. The protection means prevents a pressure member of the load cell from contacting the ground. In a weighing position, the pressure member is coupled directly, or thru a extension foot to the ground, such that the load cell of the load sensor bears the load of the platform.

The following descriptions of the different compression type load sensor embodiments are intended for use with any sheer beam and/or shear plate free platform. One type of compression type load sensor is described in use with the pallet-scale embodiments by example only, as those skilled in the art will appreciate that the other compression load sensor embodiments can be used with equal effectiveness. The compression type load sensors described herein are simply referred to as load sensors.

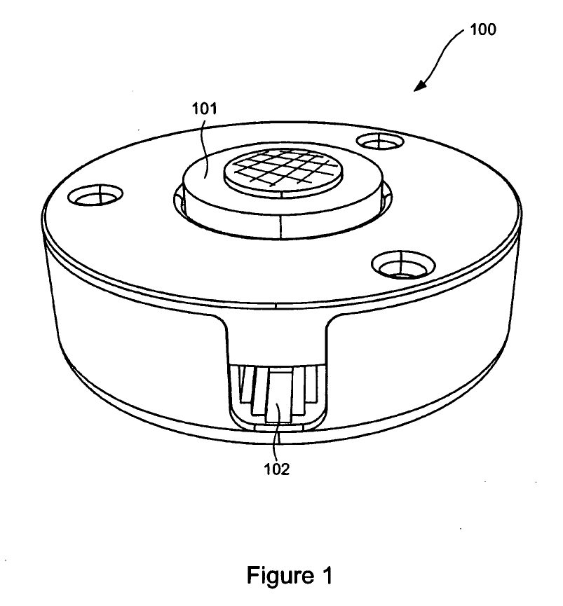

In FIG. 1, there is illustrated in a perspective view, a load sensor, generally indicated by reference numeral 100. The load sensor houses a load cell (not shown), and includes a mechanical relay 101 and an electronic connection 102, such as a jack. The mechanical relay 101 is physically coupled to a load sensing arm for deflecting the arm. The load sensor body can be constructed of any material, and the jack is integrated into the load sensor body. The relay can be constructed of any material, and is allowed to slide in an aperture of the load sensor body.

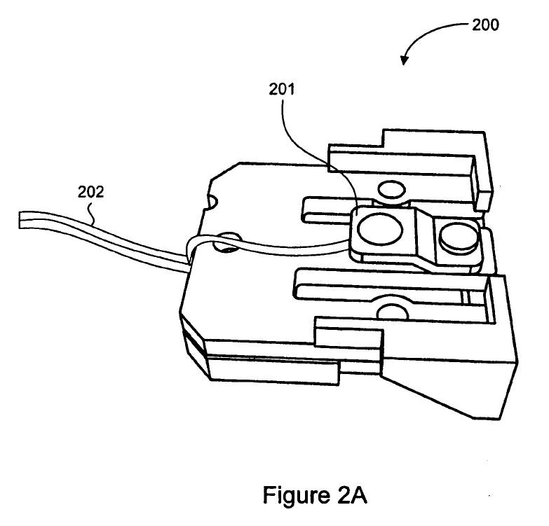

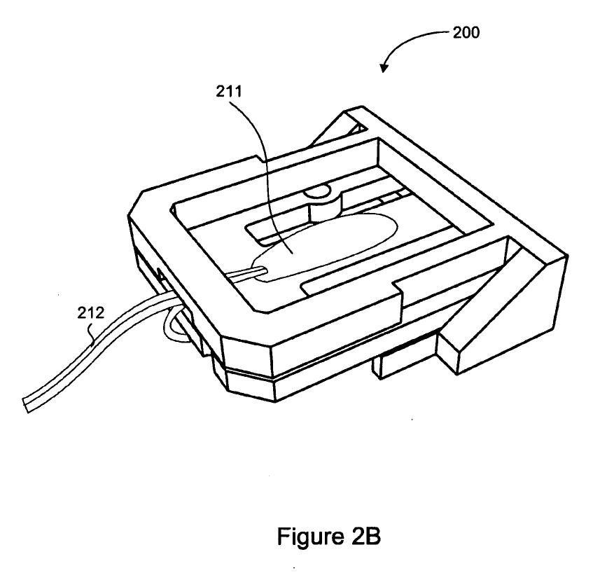

Loads cells come in different shapes and forms. One example configuration is shown in top and bottom perspective views in FIGS. 2A and 2B, respectively, and is generally indicated by reference numeral 200. In general, a load cell is an electro-mechanical device that is used to convert a force into an electrical signal. Through a mechanical arrangement, usually a load arm or pressure member 201, the force being sensed deforms a strain gauge 211 The strain gauge converts the deformation into an electrical signal. The electrical signal of the load cell 200 is then used to calculate the force applied to the load cell 200.

The extension foot 101 of the load sensor is in physical communication with the arm 201 in order to transfer any force applied to the extension foot 101 to the arm 201. The load cell 200 is electrically connected, usually via an electrical cable 202, to the jack 102 of the load sensor 100 for outputting the signal of the load cell 200.

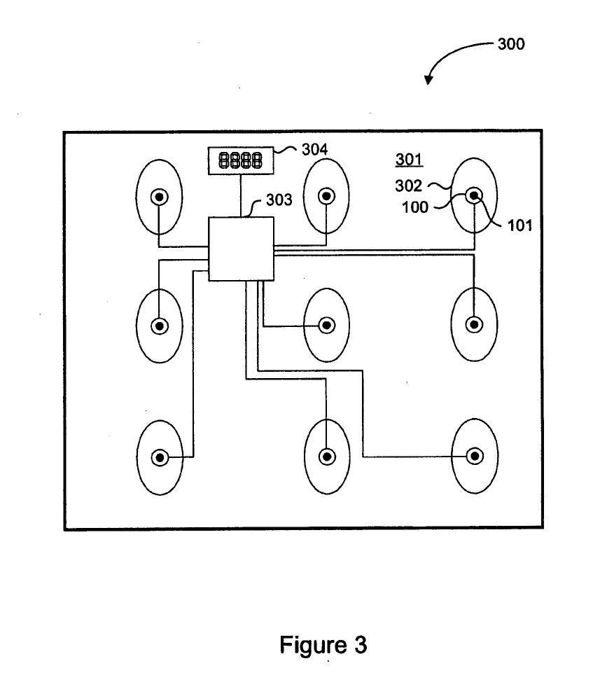

Referring to FIG. 3 now, there is illustrated in a bottom perspective view, a pallet-scale 300 in accordance with an embodiment of the present invention. The pallet-scale 300 includes a nestable platform 301 having nine legs 302, with a load sensor 100 mounted on each leg 302 such that when the platform 301 is supported on its legs 302, the load sensors 100 are positioned between the legs 302 and the ground with their extension feet 101 in contact with the ground. The platform 301 can be constructed of any material, such as wood, lightweight metal, plastic, or any material of sufficient structural integrity to support a load. Notably, platform 301 does not include a shear plate assembly, which refers to any one or more of metal channels to support the shear plates that are welded to the weighing structure, that should be understood to include any one of floor resting load beams, a shear beam coupled to the load beams and shear plates for transferring the force of the load from the platform to the shear plates, which is typically used in standard floor scales as is well known in the art. The purpose of the legs 302 is to provide a space between the pallet and the ground, which would allow the fork of a forklift to be inserted therebetween for lifting the pallet-scale 300 for transportation. The length and spacing of the legs 302 is selected to ensure proper clearance for the forklift forks.

Placing a load on top of the platform 301 would apply a downward force on the pallet corresponding to the weight of the load. This downward force is transmitted to the pallet's legs 302 and, therefore, to the load sensors 100 such that the sum of the individual forces applied to all nine load sensors 100 corresponds to the weight of the load. Different load sensors 100 with different load capacities could be used to provide for different ranges of capacity ratings for the pallet-scales 300. While the example pallet described above includes 9 load sensors, any number of load sensors can be used, provided the pallet is suitably supported when loaded with objects or materials.

The mounting of the load sensors on the legs 302 can be achieved in any way well known by those skilled in the art. As will be discussed later, the load sensors can be permanently fixed to the legs 302 or releasably attached to the legs 302. The load sensors 100 should be mounted in a manner that ensures that all their extension feet are in contact with a level ground. The load sensors and display are designed in such a fashion as to provide accurate readings on uneven surfaces where one or more load sensors may not be in contact with a ground. Since the weight can be distributed to fewer load sensors, the magnitude of deflection of the strain gauge of those load sensors in contact with the ground would be greater than if all the load sensors shared the load. Hence the aggregate data signal will still correspond to the actual weight of the load.

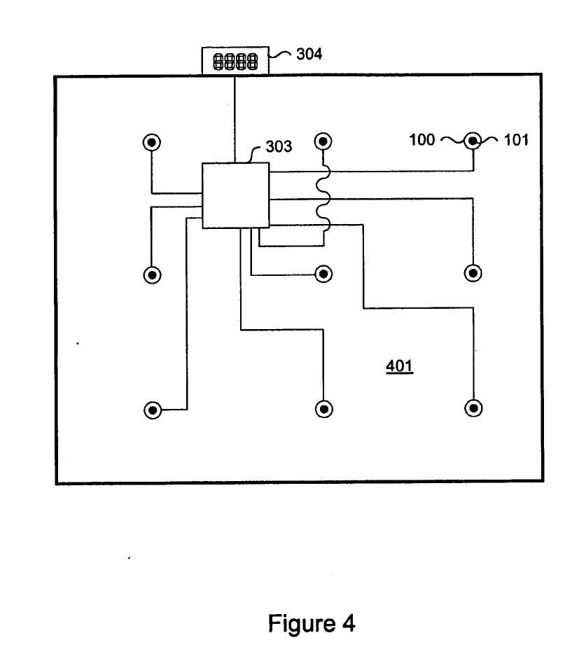

In another embodiment of the invention, which is shown in FIG. 4, the load sensors 100 can be applied to pallet-scale 400 having a stackable or rackable platform 401 (a pallet with no legs), wherein the load sensors 100 can be applied directly and usually in uniform distribution to the undersurface of the platform 401. Once again, the platform 401 is free of a shear plate assembly to minimize the weight of the pallet-scale 400.

Likewise, the load sensors 100 can be mounted to the undersurface of the platform 401 in any way well known by those skilled in the art, so long as when they are supporting the platform 401 over the ground, all of the extension feet 101 are in contact with a level ground surface. As before, the load sensors and display unit are designed to provide accurate readings on uneven ground surfaces.

Although FIGS. 3 and 4 show the invention applied to industrial pallets having platforms for receiving loads to be weighed, the embodiments of the invention are applicable to any type of platforms of any shape that can receive loads. As previously mentioned, the advantage of using platforms free of a shear plate assembly to minimize weight and allow for improved portability.

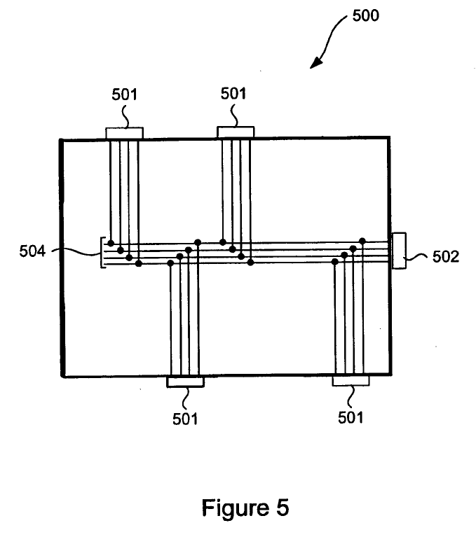

As discussed above, the load cell 200 is electrically connected to the jacks 102 of the load sensors 100 for outputting the weight data signal of the load cells 200. In the present embodiment, each load sensor 100 outputs its weight data to a junction box 303. An example junction box is shown in FIG. 5, generally indicated by reference numeral 500. The junction box 500 includes four input jacks 501 for connecting four load sensors 100 to the junction box 500. According to a present embodiment, the junction box designed for this application, unlike those used in conventional floor scales, is permanently sealed for securing the jacks, and requires no maintenance. The use of standard jacks and plugs makes unnecessary the task of wiring and unwiring individual load cells for installation or maintenance. By example, the input jacks 501 and the output jack 502 can be RJ-11 jacks or RJ-45 jacks, for receiving cables terminated with complementary RJ-11 and RJ-45 plugs respectively. These and other similar standard jacks can be used to enable releasable connection of cables to the junction box. Furthermore, by designing load sensors of precise and matching resistance, the need to make electronic adjustments to the output of individual load sensors is unnecessary. Those skilled in the art will understand that the number of input jacks can be scaled directly with the number of load sensors being used. The junction box integrates or adds the signals from the load sensors to provide a combined weight result data. The junction box 500 also has one output jack 502, referred to as a box output connector, for sending the aggregate weight signal, called the combined weight result data, to a display unit having a display for providing the weight of the load.

FIG. 5 further illustrates the general wiring internal to the junction box 500. The wiring is typically formed as conductive tracks on a PCB board, also referred to in the present embodiments as a summing board. The box output connector 502 is connected to a signal bus 504 consisting of four wires; +EXT, −EXT, +SIG and −SIG. Excitation +EXT, −EXT are essentially a static voltage provided by the display unit, for powering each of the load sensors connected to the junction box 500. Signals +SIG and −SIG are the signals provided by each load sensor, in millivolts for example, corresponding to a deflection of the strain gauge of each load sensor in response to a load. Each of the electrical connectors 501 has corresponding wires +EXT, −EXT, +SIG and −SIG connected in parallel to the signal bus 504. Persons of skill in the art should be familiar with the function of the junction box in relation to the load sensors it is connected to.

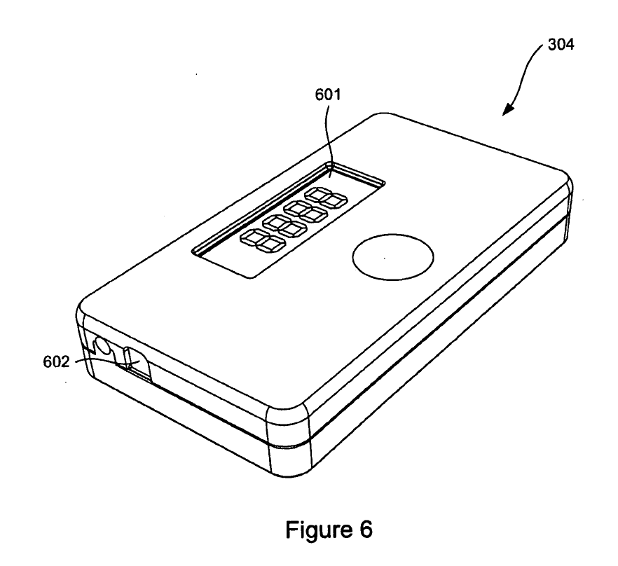

An example display unit is shown in FIG. 6, generally indicated by reference numeral 304. The display unit 304 can be mounted to any side of pallet 300 of FIG. 3 or pallet 400 of FIG. 4 by using a display bracket. Alternatively, the display can be mounted remotely on a desk, wall or other appropriate surface with or without the use of a display bracket. The display 601 of the display unit 304 can be an LCD, an LED, or any other type of display suitable for displaying the weight of the load. The display unit 400 can be powered in different ways, for example by battery, AC adaptor to provide a DC voltage, solar power, by integrated rechargeable batteries, or a combination thereof.

The jacks of the load sensors 102, the junction box 501,502, and the display unit 602 could be any type of jacks, which in combination with cables terminated with the corresponding plugs, would allow the load sensors 100 to be electrically connected to the junction box 303, and the junction box 303 to be electrically connected to the display unit 304. Connecting the load sensors 100 to the junction box 303 allows the junction box 303 to receive weight data signals from each load cell 200; similarly, connecting the junction box 303 to the display unit 304 allows the display unit 304 to receive the aggregate load signal for processing. Two example jacks are the 6P4C (commonly RJ-11) and 8P8C (commonly RJ-45) jacks, which would allow the load sensors, the junction box and the display unit to be connected by respective 6P4C and 8P8C plug terminated cables, such as standard telephone and LAN cables, for example. Of course, any other standard or customized complementary connectors can be used.

According to an alternate embodiment, the display unit 304 could be in a remote physical location and connected wirelessly to the junction box 303 by using either wireless components that plug into such jacks, or wireless components instead of jacks. Wireless technology such as radio frequency (RF), Blue Tooth or WiFi can be used for communicating the data wirelessly. In the embodiment where the jack is replaced by wireless communication circuits, the load sensor can house the necessary circuits for converting the weight data signal from the load cell into a corresponding wireless signal. For example, an analog to digital converter (ADC) converts the analog weight data signal into digital form, and then a transceiver or transmitter transforms the digital data signal into a wireless signal. In the embodiment where a wireless component is plugged into the jack, the wireless component can be a module housing the aforementioned ADC and transceiver, as well as a suitably shaped plug complementary to the jack. Also, the display unit 304 can be fitted with a USB interface/port (not shown) for sending the weight of the load to a computer or a computer network for integration into an inventory system or a shipping and receiving system. Further, the weight of the load can be sent wirelessly (or otherwise) directly from the junction box to a computer, a computer network, or a portable device; therefore, eliminating the need for a separate display unit. In the latter embodiment, the weight of the load could be displayed on a computer monitor or the portable device.

The embodiments of the present invention could as well be practiced without the use of a junction box, in which case the display unit would include (1) a plurality of input jacks for connecting the display unit directly to the load sensors for allowing the display unit to receive the weight data of each individual load sensor, (2) a summing board as the one described above in connection with the junction box, for integrating the signals received from each of the load sensors, and (3) display circuitry to process the integrated signal and display a value for the weight of the load.

Due to the industrial environments in which these pallet-scales 300,400 are used, it is desirable that the load sensors 100 are protected from rough handling. For example, the tines of a fork lift can accidentally strike the load sensors attached to the legs of pallet 300. One simple form of protecting the load sensors 100 is to adapt them to be detachably mountable to the pallets—that is, to the legs 302 of a nestable platform 301 or to the undersurface of a stackable platform 401—so that the load sensors 100 can be detached from the pallets and safely stored when the pallet is not in use as a scale. Adapting the load sensors 100 to be detachably mountable to the platform 301,401 could be done by using any suitable detachable mounting means, such as screws and nuts where the user can secure the load sensors to the platform when the scale functionality is desired, and unscrew and safely store them separately when no further scale functionality is required, ie. During transport. Another technique for detachably mounting the load sensors is to thread a portion of the body of load sensor 100 such that it mates with a corresponding threaded hole or aperture in the bottom of the platform.

As mentioned above, load cells come in different shapes and forms and, needless to say, different forms of protection means are used to protect these load cells. The above-discussed protection means, for example, is suitable for protecting load cells housed within the load sensor 100 of FIG. 1, since it would not be a complicated task to fit such a housing with detachable mounting means. While the housing of load sensor 100 protects the load cell within, the extension foot is still exposed and can be damaged from wear or can be accidentally detached from the load arm. Therefore, while the load cell is protected from damage, the extension foot must be protected as well to prevent overloading the load arm of the load cell during handling of the pallet.

As will be discussed in greater detail below, the following load sensor embodiments can be permanently attached to the platform of the previously described pallets or to other suitable weighing platforms. The protection means of these alternate load sensors include spacing means for spacing the load cell from the ground to prevent any force from being applied to the load arm of the load cell when the pallet is not being used as a scale, and extension feet to couple the load cell to the ground when the pallet is being used as a scale for relaying a force to the load arm of the load cell.

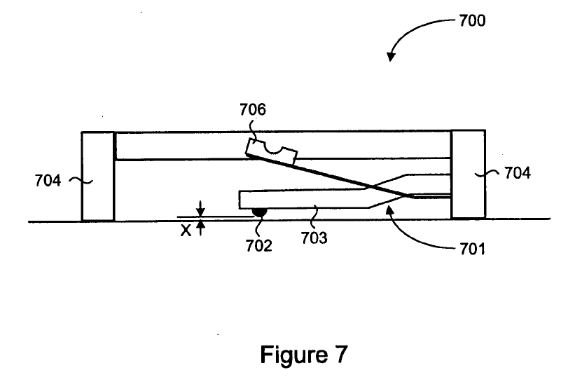

FIG. 7 shows in cross-section an alternate load sensor embodiment, generally indicated by reference numeral 700, partially housing a load cell 701. Load cell 701 includes a load pin 702 physically connected by an arm 703 to a strain gauge (not shown). Any force exerted on the pin 702 will cause the arm 703 to deform where the strain gauges are located. The load cell 701 is partially housed by spacing means, such as an annular leg 704 surrounding the load cell 701 and extending downwardly beyond the pin 702 by a distance X. Distance X is selected such that when the load sensor is mounted to the bottom of the pallet, the annular leg 704 engages the ground to support the pallet over the ground, while load pin 702 remains suspended freely within the leg 704 over the ground, as shown in FIG. 7. The annular leg 704 can be replaced by individual legs or side-walls dimensioned to support a maximum load on the platform without deformation. The annular leg 704 in combination with the leg pivotably attached for selective engagement with the load cell is one embodiment of protection means for the load cell.

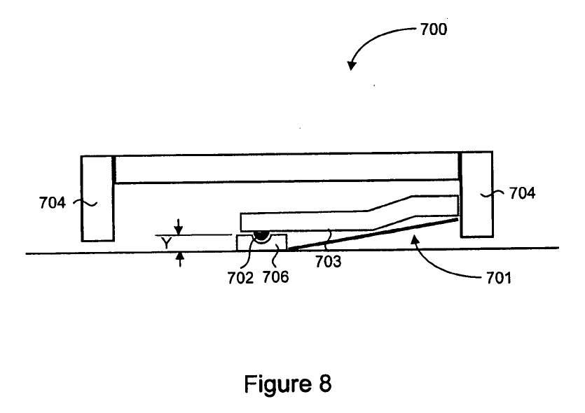

The load sensor 700 also includes a extension foot 706 dimensioned to have a thickness Y, which is larger than distance X, the extension foot being pivotably connected to the load sensor 700 by a flexible arm, so that it can swing between a first position (FIG. 7), where the extension foot is not positioned between the load pin 702 and the ground, and a second position (FIG. 8), where the extension foot 706 is positioned between the load pin 702 and the ground. Since the thickness Y of the extension foot 706 is larger than distance X, in the second position (FIG. 8), the annular leg 704 is suspended over the ground, while the extension foot 706 supports the platform of the pallet over the ground by means of the load cells 701, thereby allowing arms 703 to deform under a load. Therefore, the weight of the load on the pallet can be determined.

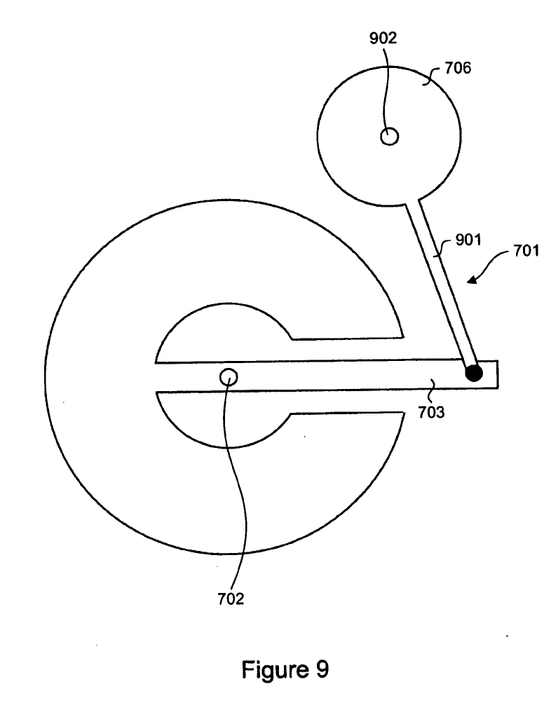

FIG. 9 provides a bottom view of the embodiment of FIG. 7. The extension foot 706 is pivotably connected to the load sensor by a resilient support arm 901. Although the extension foot 706 is shown as a circular disc in FIG. 9, other shapes could be used provided the thickness of the formation is sufficient to suspend the leg 704 above the ground when engaged with pin 702. The extension foot 706 can include a recess 902 for receiving the load pin 702 in the second position, as shown in FIG. 8, to facilitate alignment.

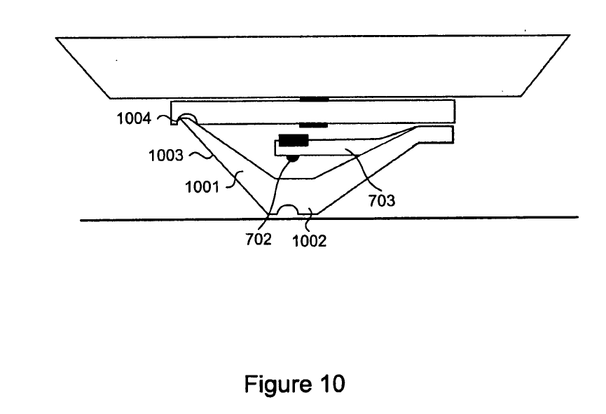

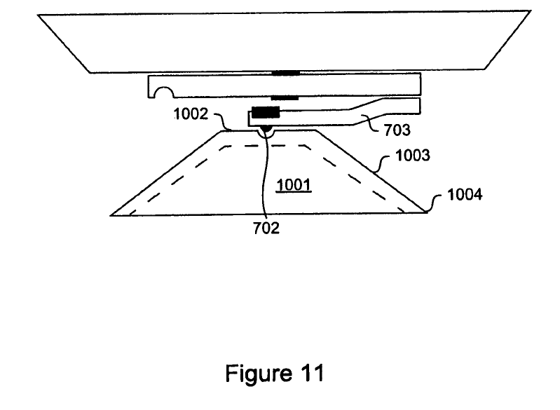

FIGS. 10 to 12 show another alternate load sensor embodiment, where the load cell is not partially housed. Like parts of the load cell have been given the same reference numerals. The protection means in the present embodiment includes a cup-shaped spacer 1001 having a horizontal base 1002 with an integral angled sidewall 1003 extending therefrom and terminating in a rim 1004. The cup-shaped spacer 1001 substantially houses the load cell 701 when the pallet is not being used as a scale (FIG. 10), allowing the load pin 702 to be suspended freely within the sidewall 1003 of the spacer 1001. In this position, pin 702 does not make contact with the ground. When the pallet is to be used as a scale, the spacer 1001 is inverted such that base 1002 rests against pin 702 between the load pin 702 and the ground as shown in FIG. 11. Now the inverted spacer functions as an extension foot.

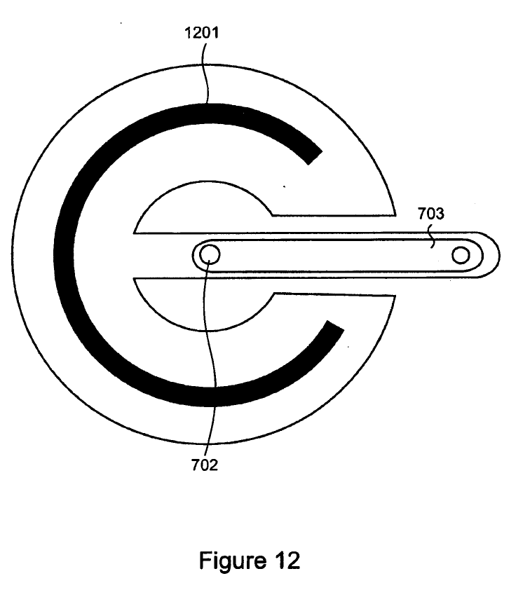

The sensor of FIGS. 10 and 11 includes a circular groove (see 1201 of FIG. 12) for receiving the rim 1004 of the spacer 1001, when the spacer 1001 is cupping the load cell 700 (FIG. 10). This ensures alignment of the spacer 1001 with the platform for proper placement.

The spacer 1001 includes a recess (not shown) to receive the arm 703 of the load cell 701 in the cupping position to minimize interference with load cell 701. Correspondingly, the groove 1201 would be shaped as shown in FIG. 12—that is, arcuately, or substantially circularly shaped—to complement the recessed part of spacer 1001. In an alternative embodiment, the size of spacer 1001 is enlarged to encompass the entirety of arm 703 of the load cell 700. For the latter, no recess is required in 1001, and the groove would be circularly shaped to receive the complete and enlarged rim of spacer 1001.

Although the cup-shaped spacer 1001 is shown as a frustum of a right circular cone in FIGS. 10 and 11, spacer 1001 can take on other shapes having a sidewall to space the load pin from the ground when the pallet is not being used as a scale, while being invertible to function as a extension foot to engage the ground and the load pin when the pallet is being used as a scale. For example, spacer 1001 can have vertical side walls instead of angled side walls.

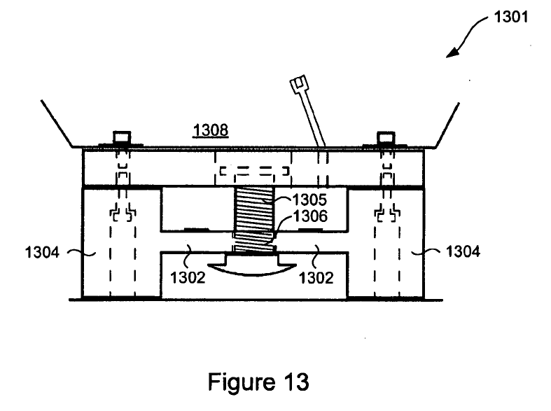

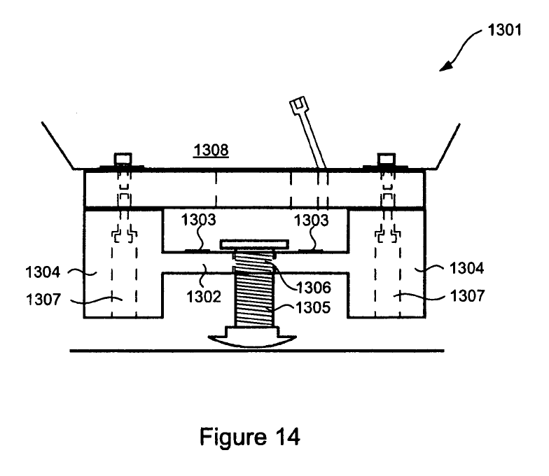

FIGS. 13 and 14 show yet another alternate embodiment of a load sensor 1301 that could be mounted to the bottom of a pallet 1308, and in particular, to the legs of the previously described nestable pallet or to the undersurface of the previously described stackable pallet. As will be apparent upon reading the following paragraphs, this load sensor includes a protection means integrated with the load cell.

Load sensor 1301 includes a spacer, such as annular wall 1304 that acts as a leg to support the pallet 1308 over the ground when the pallet 1308 is not being used as a scale, as shown in FIG. 13. As shown in FIG. 14, the annular wall 1304 includes apertures 1307 for receiving bolts to attach the load cell 1301 to the pallet 1308. The load cell 1301 includes a horizontal, centrally bored, resilient beam 1302 connected to the annular wall 1304. The bore has an inner thread 1306 to threadably engage an outer thread of a extension foot 1305.

The extension foot 1305 is rotatable between a first position as shown in FIG. 13, where it is suspended inside the annular wall 1304, such that the annular wall 1304 supports the pallet 1308, and a second position as shown in FIG. 14 where the extension foot 1305 is in contact with the ground for supporting the pallet 1308 over the ground. Because the extension foot 1305 is threaded, rotating it clockwise will retract the extension foot 1305, while rotating it counter-clockwise will extend the extension foot 1305. The linear direction of the extension foot 1305 will be reversed if the thread patterns are reversed. Accordingly, the combination of the annular leg and the retractable extension foot 1305 forms the protection means for load sensor 1301.

The flexible beam 1302 has a strain gauge 1303 connected to it such that when the extension foot 1305 is supporting the pallet 1308 over the ground, the flexible beam 1302 flexes upwardly to deform the strain gauge 1303. The strain gauge 1303 converts the deformation into an electrical signal, which is then used to calculate the downward force applied by the load.

All of the previously discussed load sensors and their associated protection means can be used with the pallets of FIGS. 3 and 4 or with any other sturdy platform. The previously described pallet-scale embodiments include load sensors having protection means, however unhoused load cells can be attached to a platform free of a shear plate assembly such that the pressure member is directly coupled to the surface.

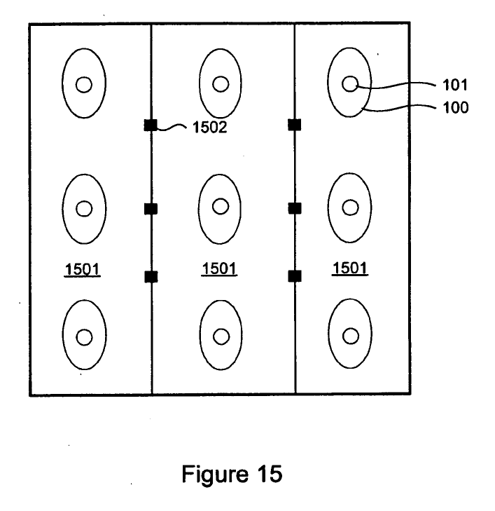

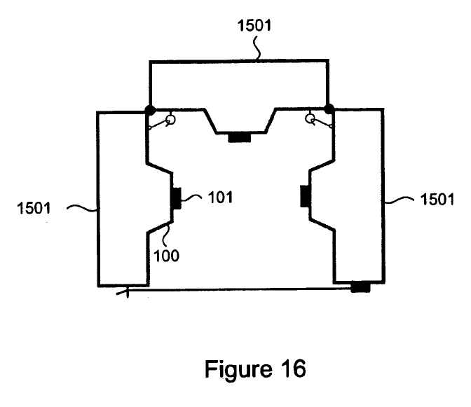

Turning now to FIG. 15, the pallet could be optionally formed of a number of foldable sections 1501 (usually three) connected to each other with hinges so the pallet can be folded and locked in the folded position, as shown in FIG. 16, for easy transportation from one location to another. FIG. 15 shows three folding sections 1501 connected by using six conventional hinges 1502. Depending on hinge selection, more or less individual hinges may be used. In the example embodiment of FIG. 15, there are two hinged regions for forming two end sections and a centre section, and the junction box 303 and display unit 304 can be connected to the center section of the foldable scale (not shown in figures). The pallet can be divided into two adjacent sections, or more sections, but it is noted that the number of sections may depend on the number and placement of the load sensors. Instead of using separate foldable sections 1501 connected by hinges 1502, the pallet could alternatively be constructed of a thermoplastic material and comprise pliable hinge-forming grooves to define the foldable sections while providing hinge connections therebetween.

In FIG. 16, the locking mechanism for locking the pallet in the folded position can either be a mechanical device adjacent to the hinges, for example, a hook-and-eye lock, and/or a strap to maintain the outer sections 1501 folded relative to the center section 1501.

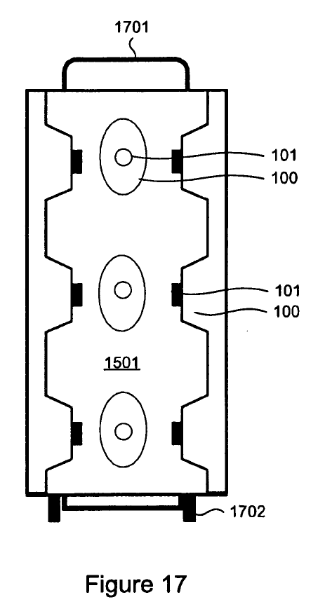

As shown in FIG. 17, the platform can be optionally fitted with a handle 1701 at one end and offset wheels 1702 on the opposite end that come in contact with the ground only when the unit is lifted. Thus, the unit can be easily moved by one person using the handle 1701 to lift the handled end, putting the wheels 1702 in contact with the ground, and then rolling the pallet along the ground. The pallet could also have a loop (not shown) for hanging it from a wall to save space and keep the unit in a secure location. In the present embodiment, the two end sections fold towards each other at an angle of approximately 90 degrees relative to the central section, for the purposes of housing the load sensors for protection during transport. However, any other angle less than 180 degrees can be used as well.

It is to be generally understood that, in this document, where the invention is described in a device-oriented fashion, the description relates to the device in its operational state—meaning, the device is in an orientation that allows each of the elements associated with the description to perform its implicit function.

Further, in the drawings, it is to be understood that standard components or features that are within the purview of an artisan of ordinary skill, and do not contribute to the understanding of the various embodiments of the invention may be omitted from the drawings to enhance clarity.

The above-described embodiments of the invention are intended to be examples only. Alterations, modifications and variations can be effected to the particular embodiments by those of skill in the art without departing from the scope of the invention, which is defined solely by the claims appended hereto.

We claim:

1. A scale, comprising:
a platform having a plurality of foldable sections;
a plurality of load sensors detachably mounted to the platform, each load sensor including a load cell;
a pressure member coupled to one or more of the load cells; and
a strain gauge coupled to each pressure member and configured to provide an electrical output when a load is applied to the platform.

2. The scale of claim 1, further including a display unit in data communication with at least one load cell.

3. The scale of claim 2, where the display unit is one of a monitor, a LCD display, and LED display.

4. The scale of claim 1, further including a junction box that is in receipt of data from at least one of the load cells and provides the data to a display unit.

5. The scale of claim 1, further including a junction box to aggregate data from the load cells with a summing board and provide the data to a display unit.

6. The scale of claim 5, where the summing board is in the junction box and is coupled to at least one of the load cells by at least one cable.

7. The scale of claim 5, where the summing board is in the junction box and is wirelessly coupled to at least one of the load cells.

8. The scale of claim 2, where the display unit is in wireless communication with at least one load cell.

9. The scale of claim 1, where the platform has at least a first section and a second section that are foldable between a planar position and a folded position along at least one folding axis.

10. The scale of claim 9, further including at least one latch to secure the platform in the folded position.

11. The scale of claim 1, where at least one load sensor includes a protection device.

12. The scale of claim 11, where the protection device supports the platform on a surface.

13. The scale of claim 12, where the strain gauge is activated by the pressure member when the protective device is in a first position without aid of any shear plate assembly.

14. The scale of claim 11, where the protection device further includes an extension foot that couples the pressure member to a surface when in a first position.

15. The scale of claim 11, where the protection device further includes an annular wall surrounding the load cell that prevents a downward force from being relayed to the pressure member.

16. The scale of claim 1, further including a handle coupled to the platform.

17. The scale of claim 16, further including at least two offset wheels located opposite from the handle, where the offset wheels engage a surface when the platform is lifted.

18. The scale of claim 17, where the platform further includes and at least one hinge enabling two ends of the platform to fold towards each other.

19. The scale of claim 1, where the plurality of load sensors further include one of four, five and nine load sensors detachably mounted to the platform.

20. The scale of claim 1, where the platform is nestable with another platform.

21. The scale of claim 2, where the display unit is in wireless communication with a junction box.

22. A load sensor mountable to a platform comprising:
a load cell with a pressure member; and
a sensor protector to prevent a downward force from being relayed to the pressure member in a first position.

22. The load sensor of claim 22, further including a strain gauge that is activated by the pressure member when the sensor protector is in a second position without the aid of any shear plate assembly.

24. The load sensor of claim 23, where the sensor protector further includes an extension foot that extends in the second position and retracts in the first position.

25. The load sensor of claim 24, where the extension foot is coupled to a resilient support arm that is coupled to a body of the load sensor.

26. The load sensor of claim 25, where the resilient support arm is pivotally connected to the body of the load sensor.

27. The load sensor of claim 24, further including a space defined by annular walls in an undersurface of the platform that surround the load cell and extend downwardly beyond the load cell with the extension foot extendable beyond the annular walls when in the second position.

28. A scale, comprising:
a platform;
at least one load sensor coupled to the platform, each load sensor having a load cell with a pressure member; and
protection means for preventing a downward force from being relayed to the pressure member in a first position.

29. The scale of claim 28, further including a strain gauge that is activated by the pressure member when the protection means is in a second position without the aid of any shear plate assembly.

30. The scale of claim 28, further including a display unit in communication with the at least one load cell.

31. The scale of claim 28, further including an extension foot that couples the pressure member to a surface when in a second position.

32. The scale of claim 28, further including a plurality of load sensors where further includes one of four, five and nine load sensors coupled to the platform.

33. The scale of claim 28, further including a handle coupled to the platform.

34. The scale of claim 33, further including at least two offset wheels located on an edge of the platform opposite from the handle, where the offset wheels engage a surface when the platform is lifted.

35. The scale of claim 28, where the platform further includes a hinge enabling two ends of the platform to fold towards each other.

36. The scale of claim 28, further including a junction box that is in receipt of data from each of the load cells and provides the data to a display unit.

37. The scale of claim 36, where the junction box aggregates the data from each of the load cells with a summing circuit.

38. A pallet, comprising:
a platform free of a shear plate assembly; and
nine load sensors detachably mounted to the platform, each load sensor including a load cell and a pressure member.

39. The pallet of claim 38, where the platform includes a plurality of foldable sections.

40. The pallet of claim 38, where each load sensor includes a protection device.

41. The pallet of claim 38, further including a junction box in receipt of data from the load cells.

42. The pallet of claim 38, further including a display unit in communication with at least one load cell.

43. The pallet of claim 38 where the platform is nestable with another platform.
